(19) United States
(12) Patent Application Publication
(10) Pub. No.: US 2023/0311011 A1
(43) Pub. Date: Oct. 5, 2023

(54) SHOW EFFECT SYSTEM FOR AMUSEMENT PARK ATTRACTION SYSTEM

(71) Applicant: Universal City Studios LLC, Universal City, CA (US)

(72) Inventors: Bryan Zebleckes, Clermont, FL (US); Heatherlyn Elizabeth Egan, Orlando, FL (US); Nathaniel David Helmick, IV, Winter Park, FL (US); Elizabeth Anne Sutphin, Winter Garden, FL (US); Rebecca Barbara Dean, Orlando, FL (US); Andrew E. Nocar, Orlando, FL (US); Elias Varon, Orlando, FL (US); Keith Michael McVeen, Winter Garden, FL (US); Gary Lynn Blumenstein, JR., Apopka, FL (US); Kimberly Marie Gritzer, Orlando, FL (US); Eric Allan Vance, Orlando, FL (US); Sarah Anne Kelley, Orlando, FL (US); Eric Rae Parr, Orlando, FL (US)

(21) Appl. No.: 18/127,481

(22) Filed: Mar. 28, 2023

Related U.S. Application Data
(60) Provisional application No. 63/326,116, filed on Mar. 31, 2022.

(51) Int. Cl. A63G 31/16; A63G 31/02; A63G 31/00

(52) U.S. Cl. CPC A63G 31/16; A63G 31/02; A63G 31/007; G06T 19/006

(57) ABSTRACT

An attraction system for an amusement park includes an actuator, an enclosure coupled to the actuator and defining an interior space of the enclosure, a display coupled to the enclosure, positioned within the interior space, and configured to output imagery, and a guest area external to the interior space of the enclosure. The actuator is configured to move the enclosure to drive movement of the display relative to the guest area for entertainment of one or more guests in the guest area.

### CROSS-REFERENCE TO RELATED APPLICATION

This application claims priority to and the benefit of U.S. Provisional Application No. 63/326,116, entitled “SHOW EFFECT SYSTEM FOR AMUSEMENT PARK ATTRACTION SYSTEM,” filed Mar. 31, 2022, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Throughout amusement parks and other entertainment venues, special effects can be used to help immerse guests in the experience of a ride or attraction. Immersive environments may include physical props and set pieces, robotic or mechanical elements, and/or display surfaces that present media. In addition, the immersive environment may include audio effects, smoke effects, and/or motion effects. With the increasing sophistication and complexity of modern ride attractions and the corresponding increase in expectations among theme or amusement park patrons, improved and more creative attractions are desirable, including ride attractions having more complex, immersive, and/or realistic special effects.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an attraction system for an amusement park includes an actuator, an enclosure coupled to the actuator and defining an interior space of the enclosure, a display coupled to the enclosure, positioned within the interior space, and configured to output imagery, and a guest area external to the interior space of the enclosure. The actuator is configured to move the enclosure to drive movement of the display relative to the guest area for entertainment of one or more guests in the guest area.

In an embodiment, a show effect system for an amusement park attraction system includes an enclosure defining an interior space, a light emitter coupled to the enclosure and configured to output a light into the interior space of the enclosure, an animated figure coupled to the enclosure and configured to move within the interior space, and an actuator coupled to the enclosure. The actuator is configured to move the enclosure and drive collective movement of the light emitter and the animated figure.

In an embodiment, an attraction system for an amusement park includes a actuator, a support coupled to the actuator and defining a space, a display in engagement with the support within the space of the support and configured to output imagery, an animated figure in engagement with the support within the space of the support and configured to move within the space, and a control system communicatively coupled to the actuator, the display, and the animated figure. The control system is configured to operate the actuator to move the support and drive corresponding movement of the display and the animated figure, operate the display to adjust the imagery output by the display, and operate the animated figure to move the animated figure within the space.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an attraction system that includes a show effect system, in accordance with an aspect of the present disclosure;

FIG. 2 is a schematic perspective view of an embodiment of an attraction system that includes a show effect system, in accordance with an aspect of the present disclosure;

FIG. 3 is a schematic perspective view of an embodiment of an attraction system that includes a show effect system and a ride vehicle, in accordance with an aspect of the present disclosure;

FIG. 4 is a schematic perspective view of an embodiment of an attraction system that includes a show effect system and an audience area, in accordance with an aspect of the present disclosure;

FIG. 5 is a schematic side view of an embodiment of a show effect system of an amusement park attraction system, in accordance with an aspect of the present disclosure;

FIG. 6 is a schematic side view of an embodiment of a show effect system of an amusement park attraction system, in accordance with an aspect of the present disclosure;

FIG. 7 is a schematic perspective view of an embodiment of a show effect system of an amusement park attraction system, in accordance with an aspect of the present disclosure;

FIG. 8 is a schematic side view of an embodiment of a show effect system of an amusement park attraction system, in accordance with an aspect of the present disclosure; and

FIG. 9 is a flowchart of an embodiment of a method or process for operating a show effect system of an amusement park attraction system, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is directed to an attraction system of an amusement or theme park. The amusement park may include a variety of features, such as rides (e.g., a roller coaster), theatrical shows, performers, and/or show set props. The attraction system of the amusement park may include a show effect system configured to facilitate entertaining guests via the features. For example, the show effect system may present various visual effects and/or audio effects to the guests within the attraction system.

As an example, the show effects of the show effect system may include a display, an animated figure, a fog effect, and so forth. Such show effects may be operated to enable the guests to perceive a certain atmosphere, such as a realistic and/or immersive environment emulated to entertain the guests. In existing attraction systems, the features of the show effect system may be positioned at a particular location. Thus, during operation of an attraction system, the guests may be positioned to view the features at the particular location. However, movement of the features from the particular location may be limited. As a result, for example, the features of the show effect system may not be experienced by guests at a different location within the attraction system. As another example, there may be limited movement of the features in unison, such as to maintain a desirable positioning of the features relative to one another. Thus, entertainment provided by the show effect systems of existing attraction systems may be limited.

Indeed, it may be desirable to move various features of the show effect system together within the attraction system to provide further entertainment to the guests. Accordingly, embodiments of the present disclosure are directed to a show effect system that includes a support and an actuation system configured to move the support. Multiple show effect components of the show effect system may be coupled to, disposed within, or otherwise accommodated by the support, such that movement of the support via the actuation system may collectively move the show effect components as a unit or group. In other words, movement of the support may drive corresponding movement of the show effect components. Furthermore, the show effect components may be configured to operate during movement of the support. For instance, the show effects provided by the show effect components may complement or supplement movement of the show effect components caused by movement of the support. As an example, a prop of the show effect components may be operated to portray a reaction or interaction to the movement of the support and/or movement relative to other components. As another example, the show effect components may be operated to portray the collective movement of the show effect components more realistically, such as to depict that the show effect components are moving without usage of the support and the actuation system. In this manner, the operation of the show effect components and the movement of the show effect components via the support and the actuation system may enhance the experience perceived by the guests.

The support may be moved to entertain guests that are positioned external to a space (e.g., an interior space) defined by the support. For example, the support may be moved relative to a ride vehicle, an auditorium, and/or a queue where guests may be positioned. By way of example, the actuation system may move the support to position the show effect components in a manner in which guests of the attraction system may more easily experience (e.g., view, hear) the show effects provided by the show effect components, such as to different locations of the attraction system to enable different guests to experience the show effects. The actuation system may also move in conjunction with monitored movement of guests (e.g., a ride vehicle holding guests or monitored movements of the guests themselves). Since the support may be separate from the guest area, service or other operations may be performed with respect to the show effect components without modifying the guest area. For example, a show effect component may be modified, removed, added, and so forth, without modifying how a guest is positioned within the guest area (e.g., to accommodate modification of the show effect system). Thus, the show effect system may be more easily modified, such as updated or adjusted, to provide desirable show effects.

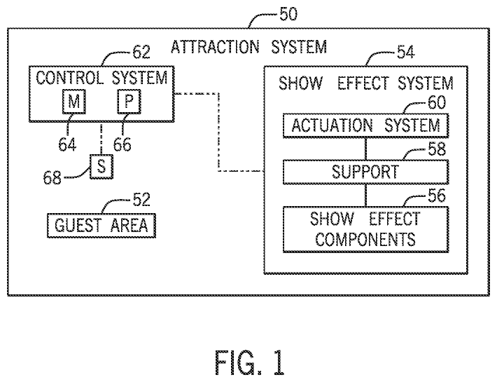

With the preceding in mind, FIG. 1 is a schematic diagram of an embodiment of an attraction system 50. The attraction system 50 may be configured to entertain one or more guests at a guest area 52 of the attraction system 50. In an embodiment, the guest area 52 may include a ride vehicle. For example, during operation of the attraction system 50, the guest area 52 may be moved (e.g., along a track, about a base) to provide movement sensations (e.g., a gravitational force, an inertial force, a postural adjustment) and/or carry the guests to different locations of the attraction system 50. In an additional or alternative embodiment, the guest area 52 may include an audience or spectator area, such as a seating arrangement, a queue, a pathway, or other location of the attraction system 50 where guests may be positioned.

The attraction system 50 may also include a show effect system 54 configured to provide entertainment to the guests at the guest area 52. For example, the show effect system 54 may include various show effect components 56, such as a display, an animated figure, an audio output device (e.g., a speaker), lighting, a smoke effect device, a fog effect device, and so forth. Operation of the show effect components 56 may entertain the guests, such as by providing an immersive or realistic environment within the attraction system 50.

The show effect components 56 may also be moved in unison, as a group, or in conjunction with one another through or within the attraction system 50. For instance, the show effect components 56 may be coupled to, disposed in, or otherwise associated with a support 58 (e.g., a frame, an enclosure) of the show effect system 54. The support 58 may be moved through or within the attraction system 50, and movement of the support 58 may drive movement of the show effect components 56. To this end, the show effect system 54 may include an actuation system or actuator 60 coupled to the support 58. Operation of the actuation system 60 may cause movement of the support 58. For example, the actuation system 60 may include a robotic arm, a winch and pulley or cable system, a parallel manipulator, or any other suitable component configured to move the support 58 (e.g., between one and six degrees of freedom). Movement of the support 58 via the actuation system 60 may drive collective movement of the show effect components 56. Thus, a threshold or desirable relative positioning between the show effect components 56 may be maintained during movement of the support 58 via the actuation system 60.

The support 58 may be separate from the guest area 52 and may therefore be moved relative to the guest area 52. For this reason, the support 58 and/or the show effect components 56 may be modified without affecting the guest area 52 (e.g., accommodation of the guests). Additionally, the guest area 52 may be modified without affecting the support 58 and/or the show effect components 56 (e.g., positioning of the show effect components 56 within the support 58). As such, the attraction system 50 may be modified more easily, such as to update or adjust how show effects are provided to entertain the guests. Similarly, other operations (e.g., a service operation, an inspection operation, a suspended operation) may be performed with respect to the show effect system 54 without affecting operation of the guest area 52, and vice versa, thereby facilitating ease of performing such operations.

The attraction system 50 (e.g., the show effect system 54) may include a control system 62 (e.g., an automation controller, a programmable controller, an electronic controller). The control system 62 may include a memory 64 and processing circuitry 66. The memory 64 may include volatile memory, such as random access memory (RAM), and/or non-volatile memory, such as read-only memory (ROM), optical drives, hard disc drives, solid-state drives, or any other non-transitory computer-readable medium that includes instructions. The processing circuitry 66 may be configured to execute such instructions. For example, the processing circuitry 66 may include one or more application specific integrated circuits (ASICs), one or more field programmable gate arrays (FPGAs), one or more general purpose processors, or any combination thereof.

The control system 62 may be communicatively coupled to the show effect components 56 and configured to operate the show effect components 56. For instance, the control system 62 may be configured to actuate the show effect components 56 to provide show effects that may be experienced by the guests at the guest area 52. The control system 62 may also be communicatively coupled to the actuation system 60 and configured to operate the actuation system 60 to move the support 58. In one embodiment, the control system 62 may operate the actuation system 60 to move the support 58 relative to the guest area 52 to position the show effect components 56 in an arrangement that enables the guests to experience the show effects provided by the show effect components 56. By way of example, the control system 62 may determine movement or positioning of the guest area 52 (e.g., movement of a ride vehicle), such as relative to the show effect system 54 (e.g., relative to the support 58, relative to the show effect components 56). The control system 62 may be configured to operate the actuation system 60 to move the support 58 and/or the show effect components 56 based on the movement or positioning of the guest area 52, such as toward or adjacent to the guest area 52 (e.g., in front of where guests are viewing at the guest area 52). Thus, the control system 62 may improve guest experience of the show effects provided by the show effect components 56. Indeed, the show effect components 56 may continue to be operated while the actuation system 60 drives movement of the support 58. In this manner, both the operation of the show effect components 56 and the collective movement of the show effect components 56 through or within the attraction system 50 may provide entertainment to the guests.

The control system 62 may operate the show effect components 56 and/or the actuation system 60 based on a parameter of the attraction system 50, such as a time of operation (e.g., of a ride cycle of the attraction system 50), a positioning of the guest area 52 (e.g., vehicle movement relative to the show effect components 56 and/or the support 58), a positioning of the support 58 within the attraction system 50, a user (e.g., guest) interaction with the show effect components 56, and so forth. To this end, the attraction system 50 may include a sensor 68 (e.g., representing one or more sensors) communicatively coupled to the control system 62 and configured to transmit data indicative of the parameter to the control system 62, and the control system 62 may be configured to operate the show effect components 56 based on the data received from the sensor 68. The control system 62 may additionally, or alternatively, be configured to operate the show effect components 56 and/or the actuation system 60 based on a received user input.

In an embodiment, the control system 62 may be configured to coordinate operation of the show effect components 56 with one another. For example, the control system 62 may operate the show effect components 56 to provide various show effects, such as visual effects and/or audio effects that complement or supplement one another to entertain the guests. The control system 62 may additionally, or alternatively, be configured to coordinate operation of the show effect components 56 with movement of the support 58. That is, the control system 62 may be configured to operate the show effect components 56 to provide show effects that complement collective movement of the show effect components 56 through or within the attraction system 50. As such, operation of the show effect components 56 and movement of the show effect components 56 via the support 58 may cooperatively provide entertainment to the guests at the guest area 52.

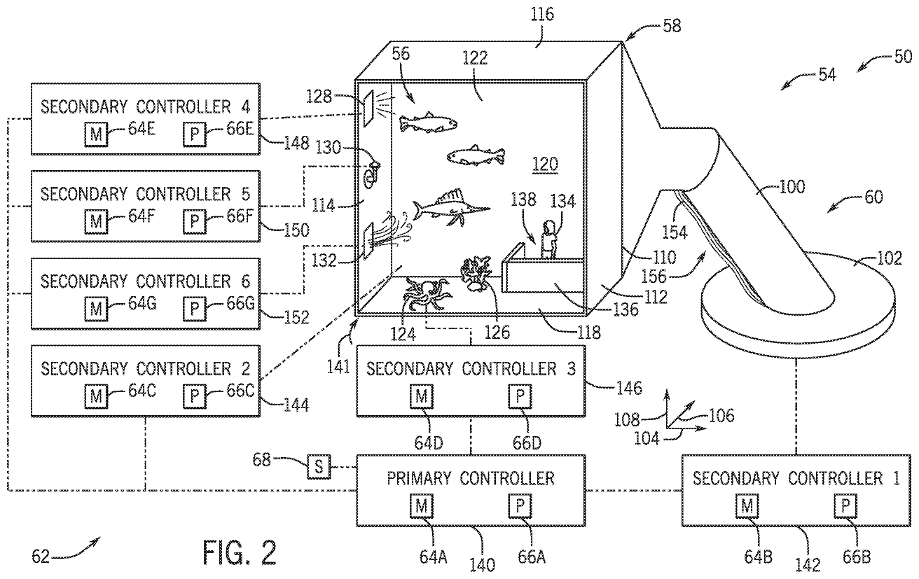

FIG. 2 is a schematic perspective view of an embodiment of the attraction system 50 that includes the show effect system 54. In the illustrated embodiment, the actuation system 60 includes a robotic arm or motion device 100 that may include multiple segments configured to move (e.g., rotate, pivot, translate) relative to one another to move the support 58. For example, one of the segments of the robotic arm 100 may be coupled to a base 102, another of the segments of the robotic arm 100 may be coupled to the support 58, and the segments may move relative to one another to move the support 58 relative to the base 102. As an example, the robotic arm 100 may be configured to translate the support 58 along a first axis 104 (e.g., a lateral axis), a second axis 106 (e.g., a longitudinal axis), a third axis 108 (e.g., a vertical axis), and/or any other suitable axis. As another example, the robotic arm 100 may be configured to rotate the support 58 about the first axis 104, the second axis 106, the third axis 108, and/or any other suitable axis. It should be noted that the axes 104, 106 and 108 are intended to represent axes of the support 58 but are shown offset from the support 58 for illustrative purposes. The base 102 may also be moved through or within the attraction system 50. In an additional or alternative embodiment, the robotic arm 100 may include any other suitable system or device configured to move the support 58 through or within the attraction system 50, such as relative to the axes 104, 106, 108.

The illustrated support 58 has a cuboid geometry. For example, the support 58 may include a first wall or panel 110 (e.g., a back wall or panel) configured to couple to (e.g., secure to, mount to, attach to) the robotic arm 100, such as to one of the segments of the robotic arm 100. The support 58 may also include a second wall or panel 112 (e.g., a lateral wall or panel) and a third wall or panel 114 (e.g., a lateral wall or panel) oriented crosswise to and extending from or coupled to the first wall 110. The third wall or panel 114 may be positioned opposite the second wall 112. The support 58 may include a fourth wall or panel 116 (e.g., a top wall or panel) oriented crosswise to and extending from or coupled to the first wall 110, the second wall 112, and the third wall 114. The support 58 may further include a fifth wall or panel 118 (e.g., a bottom wall or panel) oriented crosswise to and extending from or coupled to the first wall 110, the second wall 112, and the third wall 114 and positioned opposite the fourth wall 116. In this manner, the illustrated support 58 may be an enclosure defining a space 120 (e.g., an interior space) via the walls 110, 112, 114, 116, 118. Other embodiments may include different geometries defining an enclosure.

The show effect components 56 may be positioned within the space 120. By way of example, the show effect components 56 may include a display 122, which may be coupled directly or indirectly (e.g., via a bracket) to the first wall 110 or to any (e.g., including multiple) of the walls 110, 112, 114, 116, 118 in an additional or alternative embodiment. The display 122 may be configured to present imagery, such as one or more digital or virtual elements (e.g., an image, a video), that may provide a visual effect. For instance, the display 122 may provide a background, a scenery, and/or a setting, such as a view of a seabed having various fish to portray an underwater environment. The show effect components 56 may also include an animated FIG. 124, such as a robot, that may be coupled to or in engagement with any of the walls 110, 112, 114, 116, 118 and configured to move within the space 120. For example, the fifth wall 118 may be the ground of the seabed portrayed by the display 122, and the animated FIG. 124 may portray a sea creature (e.g., an octopus) coupled to the fifth wall 118 and moving about the ground. The show effect components 56 may further include a static or stationary prop 126, which may not substantially move within the space 120 (e.g., relative to the display 122), but may nonetheless help portray the underwater environment. For instance, the static prop 126 may include an underwater plant coupled to the fifth wall 118. The static prop 126 may facilitate lighting effects that are employed to generate changing shadows to create an illusion of movement or content (e.g., a representation of water currents in the space 120). As such, the show effect components 56 may include digital elements and real world elements to enhance show effects provided by the show effect system 54.

The show effect components 56 may further include other devices, such as an audio output device 128 (e.g., a speaker), a light emitter 130 (e.g., a light emitting diode, a compact fluorescent lamp, an incandescent light bulb, a sodium-vapor lamp), and/or a fluid output device 132 (e.g., a blower of fog machine). The audio output device 128 may be configured to output a sound, such as an ocean-related noise. The light emitter 130 may be configured to output a light effect, such as to portray sunlight or generate changing shadows (e.g., cast by the static prop 126). The fluid output device 132 may be configured to output a fluid (e.g., water, liquid nitrogen, carbon dioxide, glycol, mist) to portray a particular visual effect, such as mist, smoke, haze, and/or fog effects. Other types of show effect components 56, such as a pulley system, a fan, a vehicle, a fire output device, and so forth, may also be implemented in the space 120 (e.g., coupled to the support 58) and may provide a corresponding show effect during operation of the show effect system 54.

In one embodiment, a user 134, such as a performer, a guest, an operator, and/or a technician, may be positioned within the space 120. By way of example, the support 58 may include a partition 136, which may form a compartment or volume 138 that may accommodate the user 134. The user 134 may provide further entertainment in conjunction with operation of the show effect components 56 (e.g., by interacting with the show effect components 56). The user 134 may additionally, or alternatively, perform a service operation (e.g., inspection, maintenance) with respect to the show effect components 56 or perform any other suitable action with respect to the show effect components 56.

The various show effect components 56 may cooperatively operate to provide a realistic portrayal of an environment, such as an underwater environment. A side 141 of the support 58 (e.g., opposite to where the first wall 110 is positioned) may be exposed to enable guests to observe the show effect components 56 within the space 120. Moreover, the actuation system 60 may be configured to move the support 58 and drive movement of the show effect components 56 as a unit. For example, the actuation system 60 may move the support 58 to drive collective movement of the show effect components 56, such as in concert with one another as a stage set, thereby maintaining a relative positioning of the show effect components 56 with one another (e.g., within a threshold distance). As such, rather than individually and separately moving each of the show effect components 56 relative to the guests (e.g., to position the show effect components 56 in a desirable position relative to the guest area), the show effect components 56 may be moved together via the support 58. Thus, a complexity associated with collectively moving the show effect components 56 with one another may be reduced.

In one embodiment, the control system 62 that is configured to operate the show effect system 54 may include a primary controller 140. The primary controller 140 may be communicatively coupled to multiple secondary controllers configured to operate individual components or sets of components (e.g., the show effect components 56) of the show effect system 54. For example, a first secondary controller 142 may be communicatively coupled to and configured to operate the actuation system 60, such as to control movement and positioning of the support 58 (e.g., relative to a guest area). A second secondary controller 144 may be communicatively coupled to and configured to operate the display 122, such as to adjust the imagery output by the display 122. A third secondary controller 146 may be communicatively coupled to and configured to operate the animated FIG. 124, such as to control movement and positioning of the animated FIG. 124 within the space 120 of the support 58. A fourth secondary controller 148 may be communicatively coupled to and configured to operate the audio output device 128 and control audio effects provided by the audio output device 128. A fifth secondary controller 150 may be communicatively coupled to and configured to operate the light emitter 130 to control lighting (e.g., a direction of light, an intensity of light, a hue of light) provided by the light emitter 130. A sixth secondary controller 152 may be communicatively coupled to and configured to operate the fluid output device 132, such as to control a flow rate, a direction, and/or a velocity of fluid provided (e.g., sprayed) by the fluid output device 132.

Each of the primary controller 140 and the secondary controllers 142, 144, 146, 148, 150, 152 may include respective memories 64 and processing circuitries 66 to enable operation of the controllers 140, 142, 144, 146, 148, 150, 152 to control the show effect system 54. That is, the primary controller 140 may include a first memory 64A and first processing circuitry 66A, the first secondary controller 142 may include a second memory 64B and second processing circuitry 66B, the second secondary controller 144 may include a third memory 64C and third processing circuitry 66C, the third secondary controller 146 may include a fourth memory 64D and fourth processing circuitry 66D, the fourth secondary controller 148 may include a fifth memory 64E and fifth processing circuitry 66E, the fifth secondary controller 150 may include a sixth memory 64F and sixth processing circuitry 66F, and the sixth secondary controller 152 may include a seventh memory 64G and seventh processing circuitry 66G. Each of the secondary controllers 142, 144, 146, 148, 150, 152 may be configured to operate independently of one another. Thus, during non-operation of one of the secondary controllers 142, 144, 146, 148, 150, 152 (e.g., communicative coupling between one of the secondary controllers 142, 144, 146, 148, 150, 152 and the corresponding component of the show effect system 54 is faulty), a remainder of the secondary controllers 142, 144, 146, 148, 150, 152 may remain in operation. Thus, a portion of the show effect system 54 may continue to operate to provide a show effect that entertains guests.

In one embodiment, the primary controller 140 may be configured to communicate with and control operation of the secondary controllers 142, 144, 146, 148, 150, 152 to synchronize and coordinate operation of the show effect components 56 and/or the actuation system 60. For instance, the primary controller 140 may be configured to cause operation of the show effect components 56 and the actuation system 60 to provide show effects that effectively emulate a realistic and immersive environment. By way of example, the primary controller 140 may receive data from the sensor 68 and may communicate with and control operation of the secondary controllers 142, 144, 146, 148, 150, 152 based on the data. The secondary controllers 142, 144, 146, 148, 150, 152 may additionally, or alternatively, be communicatively coupled to one another, such as via a mesh network, and may, for example, be configured to directly communicate with one another to coordinate operation of the show effect components 56 and/or the actuation system 60. Indeed, in an additional or alternative embodiment, the secondary controllers 142, 144, 146, 148, 150, 152 may be configured to operate the show effect system 54 without communicating with the primary controller 140. For instance, each of the secondary controllers 142, 144, 146, 148, 150, 152 may be configured to receive data from the sensor 68 or a separate sensor 68 and operate based on the respectively received data. The primary controller 140 may account for positioning of the guest area 52 (e.g., based on sensor data) to maneuver the show effect system 54 to provide visual access to the space 120 for viewers in the guest area 52. For example, the sensor 68 may include a motion sensor, a location sensor (e.g., a barcode reader that detects location based on designated barcode placement along a path), a shape detector (e.g., facial recognition or body recognition sensor), a gaze detector (e.g., eye position detection camera), or the like that provides data about guests within the guest area 52 or about the guest area 52 itself (e.g., a ride vehicle orientation or location). The primary controller 140 (or another controller) may employ the data to control the actuation system 60 to position the show effect system 54 in a manner that facilitates viewing of the space 120 by the guests in the guest area 52.

Operation of the show effect components 56 and/or the actuation system 60 may be synchronized with operation of a remainder of the attraction system 50. For example, operation of the show effect components 56 and/or the actuation system 60 may enable show effects to be provided to entertain the guests at the guest area. In an embodiment, the show effect components 56 and/or the actuation system 60 may be coordinated to operate in a predetermined manner, such as to cause the show effect system 54 to provide predetermined show effects at certain times of operation of the attraction system 50 (e.g., during a particular time stamp of a ride cycle, in response to a determination that guests are positioned near the show effect system 54). Additionally, or alternatively, the show effect components 56 and/or the actuation system 60 may be operated based on a user input, which may be indicative of a request to provide certain show effects. Furthermore, the show effect components 56 and/or the actuation system 60 may be operated based on a user interaction, which may be indicated by the data provided via the sensor 68. For example, the user interaction may include contact between a guest and one of the show effect components 56, movement of a guest, audio input (e.g., spoken words) provided by a guest, and the like. In this manner, the control system 62 may operate the show effect system 54 to provide a more immersive, realistic, and/or interactive experience to the guests, such as an experience that is more customized and/or personal (e.g., rather than providing pre-programmed or preset show effects). Indeed, the control system 62 may operate the show effect system 54 in real-time based on the parameter indicated by the data received from the sensor 68 to provide different show effects, such as movement and/or actuation of the show effect components 56, for different guests.

The actuation system 60 may facilitate positioning and routing of electrical connections 154 (e.g., wiring, cable), which may be used to provide power to the show effect components 56, communicatively couple the show effect components 56 to the secondary controllers 142, 144, 146, 148, 150, 152 to operate the show effect system 54, and so forth. As an example, the electrical connections 154 may be coupled to and routed along the robotic arm 100. For instance, the robotic arm 100 may include a flexible tubing, sheath, or sleeve 156 that may support the electrical connections 154 and secure the electrical connections 154 to the robotic arm 100 (e.g., maintain contact between the electrical connections 154 and the robotic arm 100). During movement of the robotic arm 100 (e.g., to move the support 58), the tubing 156 may flex and maintain securement of the electrical connections 154 to the robotic arm 100. The tubing 156 may also shield the electrical connections 154 from external elements, such as dust and debris. The electrical connections 154 may extend into the space 120 of the support 58 to couple to the show effect components 56. By way of example, any of the walls 110, 112, 114, 116, 118 may include an opening, and the electrical connections 154 may be inserted through the opening to couple to the show effect components 56 disposed within the space 120, thereby enabling operation of the show effect components 56.

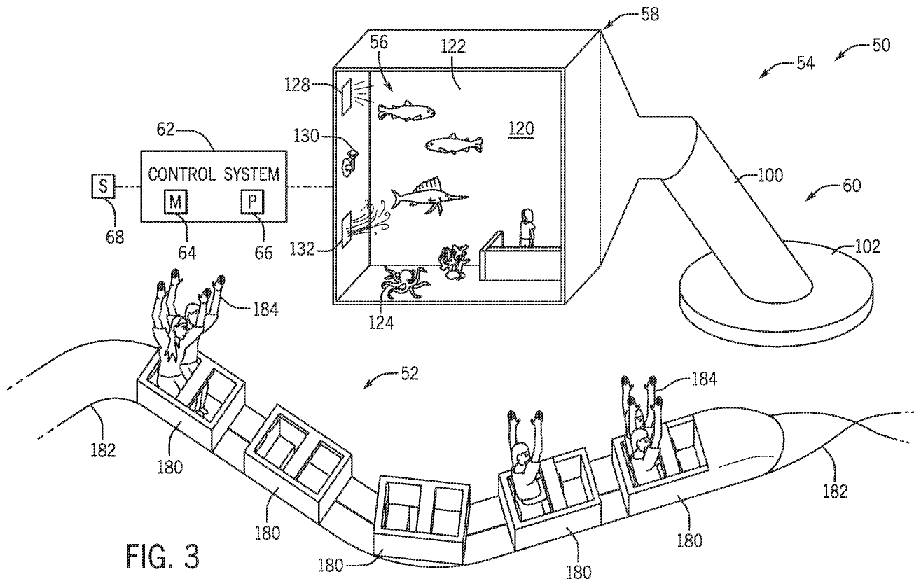

FIG. 3 is a schematic perspective view of an embodiment of the attraction system 50 that includes the show effect system 54. In the illustrated embodiment, the guest area 52 includes a ride vehicle 180, which may be configured to navigate along a path or track 182 of the attraction system 50 exterior to the space 120 of the support 58. Guests 184 may be positioned within the ride vehicle 180, and the show effect system 54 may provide a show effect to entertain the guests 184 as the ride vehicle 180 travels along the path 182. By way of example, the control system 62 (e.g., the primary controller 140, the first secondary controller 142 of FIG. 2) may be configured to operate the actuation system 60 to position the support 58 and enable the guests 184 to experience (e.g., view, hear) the show effects. In one embodiment, the control system 62 (e.g., the primary controller 140 of FIG. 2) may be configured to receive data from the sensor 68, and the data may indicate a positioning of the ride vehicle 180 (e.g., along the path 182). Based on the data, the control system 62 may be configured to operate the actuation system 60 to move the support 58 to a target positioning, such as relative to the ride vehicle 180. Additionally, the control system 62 may be configured to operate the show effect components 56 to provide certain show effects (e.g., certain imagery output by the display 122, certain movement of the animated FIG. 124, certain audio effects provided by the audio output device 128, certain light effects provided by the light emitter 130, certain fluid effects provided by the fluid output device 132) based on the data.

For instance, the control system 62 may coordinate the show effects provided by the different show effect components 56 (e.g., via communication between the controllers 140, 142, 144, 146, 148, 150, 152 of FIG. 2) based on the data to entertain the guests 184 in a particular manner suitable for the positioning of the guests 184 via the ride vehicles 180. By way of example, the control system 62 may actuate the show effect components 56 to portray that the elements of an underwater environment are reacting to the ride vehicle 180 and the guests 184 passing by the elements in order to provide a realistic appearance that the ride vehicle 180 is navigating through the underwater environment. Indeed, operation of the control system 62 to operate the show effect components 56 may be based on a parameter associated with the guests 184, including a behavior of the guests 184 (e.g., change in gaze, spoken words) within the ride vehicles 180, as detected by the sensor 68 to provide a more immersive experience for the guests 184.

Although the illustrated ride vehicle 180 is configured to travel along the path 182, in an additional or alternative embodiment, the ride vehicle 180 may be configured to move within the attraction system 50 in any other suitable manner. For example, the ride vehicle 180 may be coupled to an actuator (e.g., another robotic arm or motion device) configured to drive movement, such as rotational and/or translational movement, of the ride vehicle 180 (e.g., relative to another base). In any case, the show effect system 54 may be configured to move the support 58 to entertain the guests 184 in the ride vehicle 180 via show effects, such as in addition to entertainment provided by movement of the ride vehicle 180.

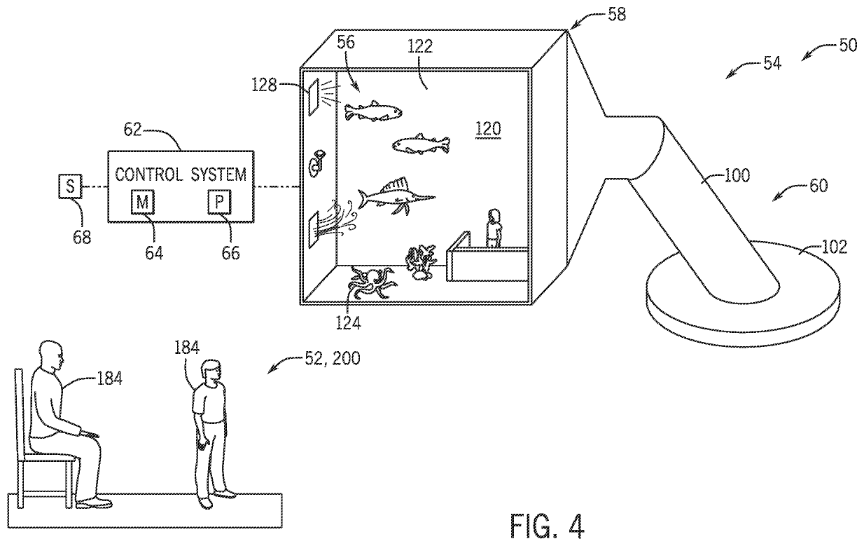

FIG. 4 is a schematic perspective view of an embodiment of the attraction system 50 that includes the show effect system 54 and the guest area 52, which may include an audience area 200 that is external to the space 120 of the support 58. The guests 184 may be positioned in, such as seated or standing within, the audience area 200. By way of example, the audience area 200 may include a pathway (e.g., a queue) along which the guests 184 may navigate, an auditorium where the guests 184 may be positioned to view a show (e.g., provided by the show effect system 54), an entrance or exit of the attraction system 50, and the like. In an embodiment, the audience area 200 may remain stationary during operation of the attraction system 50. In an additional or alternative embodiment, the audience area 200 may be configured to move, such as rotate, to enable the guests 184 to view different parts of the attraction system 50. The guests may also move within the audience area 200 to view different parts of the attraction system 50.

The control system 62 may be configured to operate the show effect system 54 to entertain the guests 184 at the audience area 200. For example, the control system 62 may be configured to operate the actuation system 60 to move the support 58 and enable the guests 184 to experience the show effect components 56. In an embodiment, the control system 62 may be configured to determine a parameter associated with the guests 184 (e.g., via data received from the sensor 68), such as a positioning, an occupancy, a viewing perspective, a user interaction or other behavior, and so forth, and the control system 62 may be configured to operate the actuation system 60 to move the support 58 based on the parameter. The control system 62 may additionally, or alternatively, be configured to operate the show effect components 56 to provide certain show effects based on the parameter associated with the guests 184 to provide a more interactive experience to the guests 184.

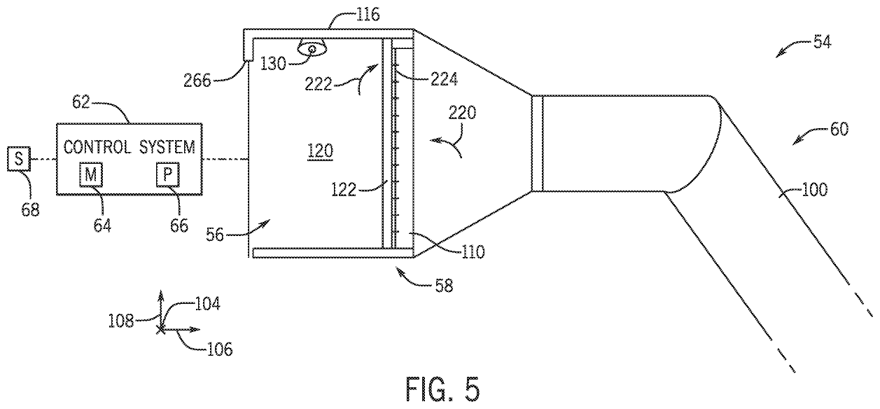

FIG. 5 is a schematic side view of an embodiment of the show effect system 54. Certain components of the show effect system 54, such as the second wall 112 and certain show effect components 56, are not illustrated for visualization purposes. The robotic arm 100 may be coupled to a first side 220 (e.g., an exterior side) of the first wall 110, and the display 122 may be coupled to a second side 222 (e.g., an interior side), opposite the first side 220, of the first wall 110.

Additionally, reinforcement 224 (e.g., bracing, backing, a stiffener) may be used to block deformation of the display 122 to maintain a shape (e.g., a planar geometry) of the display 122. By way of example, the reinforcement 224 may be engaged with or mounted to the display 122, and the reinforcement 224 may be coupled to the first wall 110 to secure the display 122 to the first wall 110. The reinforcement 224 may block movement of the support 58 from deforming or distorting (e.g., bending, flexing, twisting) the display 122. For example, during operation of the actuation system 60 in which the robotic arm 100 may impart a force onto the first wall 110 to drive movement of the support 58, the reinforcement 224 may block force from being transferred from the first wall 110 onto the display 122 to block deformation of the display 122 caused by a force imparted onto the display 122. As such, the reinforcement 224 may maintain a structural integrity of the display 122 and/or increase a useful lifespan of the display 122.

The show effect components 56 may also include the light emitter 130, which may be disposed in the space 120 and coupled to the fourth wall 116. A projection 226 (e.g., a lip, a partition, a wall, an extension, a ledge, an overhang) may extend from the fourth wall 116 (e.g., along the third axis 108) and overlap (e.g., vertically overlap) with the light emitter 130 about the third axis 108. The projection 226 may block a field of view from the guests at the guest area to the light emitter 130. Thus, the guests may not be able to see the light emitter 130 from the guest area, and the light emitter 130 may be covered or concealed by the projection 226. In this manner, the guests may perceive that the light being output by the light emitter 130 into the space 120 is more naturally and/or mysteriously provided. The show effect system 54 may also include other features, such as a shroud, a mirror, a reflector, glass, a beam splitter, to block the view of other show effect components 56 and/or otherwise manipulate the show effect (e.g., lighting) provided by the show effect components 56 to enhance the show effects and entertain the guests.

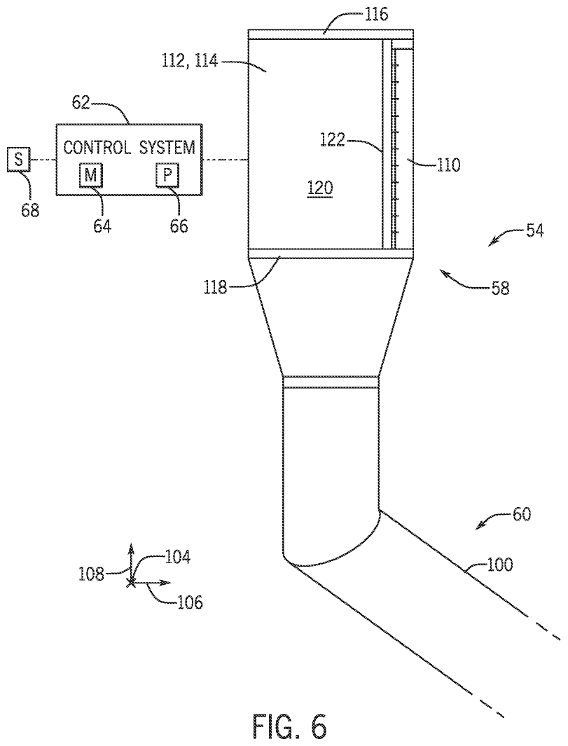

FIG. 6 is a schematic side view of an embodiment of the show effect system 54. In the illustrated embodiment, the display 122 is coupled to the first wall 110, and the robotic arm 100 is coupled to the fifth wall 118. Thus, the robotic arm 100 and the display 122 may be coupled to different walls of the support 58. Indeed, the robotic arm 100 and the display 122 may be coupled to any suitable combination of the walls, portions, or other parts of the support 58, such as to a common wall or to separate walls. For example, in an additional or alternative embodiment, the robotic arm 100 may be coupled to the second wall 112, the third wall 114, and/or the fourth wall 116. In each of such embodiments, the actuation system 60 may be configured to move the support 58 via the robotic arm 100, such as to enable the guests to view the show effects provided by the show effect system 54 (e.g., in the space 120). Specifically, the control system 62 may control the robotic arm 100 to facilitate guests' viewing based on sensor data that indicates a location of the guests (e.g., individually or as a group).

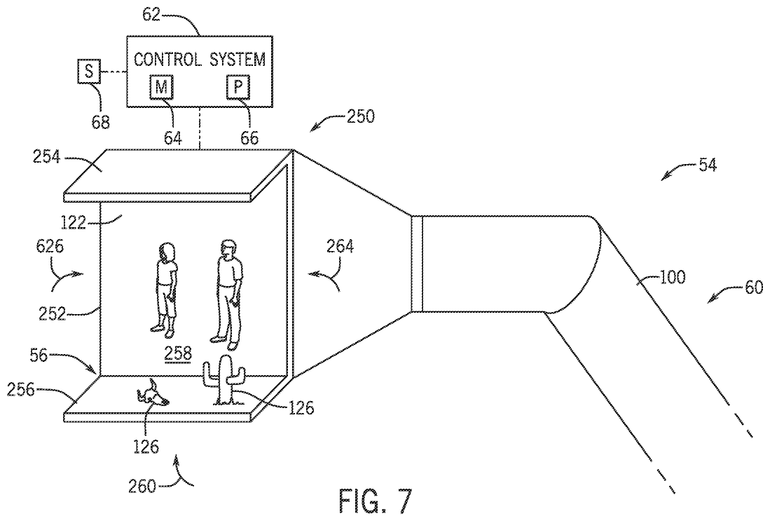

FIG. 7 is a schematic perspective view of an embodiment of the show effect system 54. The show effect system 54 may include a support 250, which may have fewer walls or panels as compared to the support 58 illustrated in FIGS. 2-6. For example, the support 250 may include a first wall or panel 252, a second wall or panel 254 (e.g., a top wall) oriented crosswise to and extending from or coupled to the first wall 252, and a third wall or panel 256 (e.g., a bottom wall) oriented crosswise to and extending from or coupled to the first wall 252. The second wall 254 may be positioned opposite the third wall 256. However, the support 250 may not include walls or panels (e.g., lateral walls or lateral panels) that are coupled to each of the first wall 252, the second wall 254, and the third wall 256. Thus, the support 250 may define and partially enclose a space 258, which may be exposed at a first side 260 of the support 250 (e.g., opposite to where the first wall 252 is positioned), a second side 262 (e.g., a first lateral side) of the support 250, and a third side 264 (e.g., a second lateral side), opposite the second side 262, of the support 250. In an additional or alternative embodiment, the support 250 may include a different combination of walls to define and expose the space 258 and enable the guests to view the show effects provided by the show effect system 54 (e.g., within the space 258).

In an embodiment, the robotic arm 100 may be coupled to the first wall 252 (e.g., a first side of the first wall 252), the display 122 may be coupled to the first wall 252 (e.g., a second side, opposite the first side, of the first wall 252), and stationary props 126 may be coupled to the third wall 256. Other show effect components 56 may be coupled to the second wall 254 (e.g., within the space 258). Indeed, the support 250 may accommodate the show effect components 56 in any suitable manner to enable the show effects to be provided to the guests.

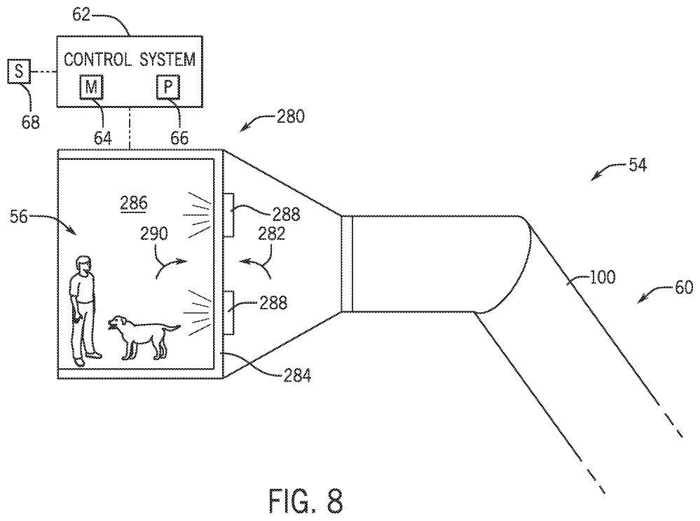

FIG. 8 is a schematic side view of an embodiment of the show effect system 54 that includes a support 280, such as the support 58 or the support 250. The robotic arm 100 may be coupled to a first side 282 (e.g., an exterior side) of a first wall 284 (e.g., a back wall) of the support 280. The show effect components 56 may be positioned within a space 286 defined by the support 280. During operation of the show effect system 54, the show effect components 56 may be configured provide show effects viewable by the guests.

Moreover, the show effect system 54 may include one or more light emitters 288 coupled to the first wall 284, such as to the first side 282. The light emitter(s) 288 may be configured to output a light into the first wall 284, and the light may be at least partially visible at a second side 290 (e.g., an interior side) of the first wall 284, such as from a guest area. By way of example, the light output by the light emitter(s) 288 may provide lighting for the environment portrayed via the show effect components 56. For this reason, the first wall 284 may be at least partially transparent and/or translucent to facilitate visibility of the light output by the light emitter(s) 288. However, the first wall 284 may block or obscure visibility of the light emitter(s) 288 from the second side 290. As such, the light directed into the space 286 via the light emitter(s) 288 may appear to be more naturally or mysteriously provided, thereby enhancing the show effect provided by the show effect system 54. In an embodiment, the show effect system 54 may not include the display 122 coupled to the first wall 284 to enable greater visibility of the light output by the light emitter(s) 288.

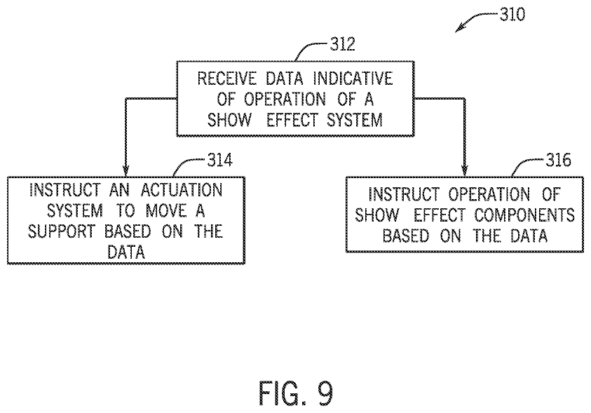

FIG. 9 is a flowchart of an embodiment of a method or process 310 for operating a show effect system (e.g., the show effect system 54 of FIGS. 1-8). Any suitable device (e.g., the processing circuitry 66 of the control system 62 of FIGS. 1-8) may perform the method 310. In one embodiment, the method 310 may be implemented by executing instructions stored in a tangible, non-transitory, computer-readable medium (e.g., the memory 64 of the control system 62). For example, the method 310 may be performed at least in part by one or more software components, one or more hardware components, one or more software applications, and the like. While the method 310 is described using steps in a specific sequence, additional steps may be performed, the described steps may be performed in different sequences than the sequence illustrated, and/or certain described steps may be skipped or not performed altogether.

At block 312, data indicative of operation of the show effect system may be received. By way of example, the data may be indicative of a parameter of an attraction system, such as a time of operation (e.g., a ride cycle of the attraction system) and/or a positioning of a guest area (e.g., positioning of a ride vehicle relative to the show effect system). For instance, the data may be received from a sensor configured to monitor the parameter. Additionally, or alternatively, the data may include a user input, such as a request to operate the show effect system.

At block 314, an actuation system may be instructed to move a support based on or in response to the data. For example, the show effect components of the show effect system may be coupled to the support, and movement of the support via the actuation system may collectively move the show effect components as a unit. In one embodiment, the actuation system may move the support toward or adjacent to the guests (e.g., at the guest area) to enable the guests to experience the show effect provided by the show effect components. The actuation system may additionally, or alternatively, move the support in a manner that complements or supplements other operation of the attraction system. By way of example, the guest area may include a first ride vehicle, and the show effect components may portray a second ride vehicle that is moving alongside the first ride vehicle of the guest area. As such, the actuation system may move the support to translate the show effect components alongside the first ride vehicle. The actuation system may further move the support based on a user input, which may be indicative of a requested positioning or requested movement of the support.

At block 316, the show effect components may also be instructed to operate based on or in response to the data. For instance, the show effect components may be instructed to provide particular show effects based on the data. As an example, to portray the second ride vehicle moving alongside the first ride vehicle of the guest area, the show effect components may include an animated ride vehicle figure that may move within the support, a display that may provide imagery of a moving scenery to portray movement of the second ride vehicle to different locations, an audio output device that may provide sound effects of a moving ride vehicle, a light emitter that may adjust lighting to portray movement of the second ride vehicle, a fluid output device that may output a fluid to portray smoke caused by movement of the second ride vehicle, and so forth. Thus, the show effect components may cooperatively operate to portray a particular environment or effect perceived by or otherwise entertaining the guests.

Operation of different show effect components may be coordinated with one another in order to provide desirable show effects. In one embodiment, different controllers may be configured to operate respective subsets of the show effect components, and the controllers may communicate with one another, such as via a mesh network and/or a primary or central controller, to coordinate operation of the show effect components. For instance, continuing the example above, a first controller configured to control movement of the animated ride vehicle figure may communicate with a second controller configured to operate the audio output device to move the animated ride vehicle figure in conjunction with the sound effect provided by the audio output device to realistically portray movement of the ride vehicle. Indeed, each controller may operate their associated show effect component(s) based on the operation of or show effects provided by another one of the show effect components, as effectuated by another one of the controllers.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An attraction system for an amusement park, the attraction system comprising:
an actuator;
an enclosure coupled to the actuator, wherein the enclosure defines an interior space of the enclosure;
a display coupled to the enclosure and positioned within the interior space, wherein the display is configured to output imagery; and
a guest area external to the interior space of the enclosure, wherein the actuator is configured to move the enclosure to drive movement of the display relative to the guest area for entertainment of one or more guests in the guest area.

2. The attraction system of claim 1, wherein the attraction system comprises an animated figure positioned within the interior space of the enclosure, the animated figure is configured to move within the interior space, and the actuator is configured to move the enclosure to drive collective movement of the display and the animated figure relative to the guest area.

3. The attraction system of claim 2, wherein the enclosure comprises a first wall and a second wall extending crosswise from the first wall, the display is coupled to the first wall, and the animated figure is coupled to the second wall.

4. The attraction system of claim 1, wherein the actuator is configured to drive movement of the enclosure between one and six degrees of freedom.

5. The attraction system of claim 1, wherein the guest area comprises a ride vehicle.

6. The attraction system of claim 1, comprising a control system communicatively coupled to the actuator and the display, wherein the control system is configured to control the actuator to move the enclosure and drive corresponding movement of the display, and the control system is configured to control the imagery output by the display.

7. The attraction system of claim 6, comprising a sensor configured to detect a parameter of the guest area, wherein the control system is communicatively coupled to the sensor and is configured to control the actuator based on the parameter to facilitate viewing of the interior space by the one or more guests within the guest area.

8. A show effect system for an amusement park attraction system, the show effect system comprising:
an enclosure defining an interior space;
a light emitter coupled to the enclosure, wherein the light emitter is configured to output a light into the interior space of the enclosure;
an animated figure coupled to the enclosure, wherein the animated figure is configured to move within the interior space; and
an actuator coupled to the enclosure, wherein the actuator is configured to move the enclosure and drive collective movement of the light emitter and the animated figure.

9. The show effect system of claim 8, comprising a control system configured to operate the light emitter, the animated figure, the actuator, or any combination thereof based on an operating parameter during operation of the amusement park attraction system.

10. The show effect system of claim 9, wherein the operating parameter comprises a positioning of the enclosure relative to a guest area of the amusement park attraction system, and the guest area is external to the interior space of the enclosure.

11. The show effect system of claim 9, wherein the data is indicative of a user interaction with the show effect system.

12. The show effect system of claim 8, comprising a first controller communicatively coupled to the actuator, a second controller communicatively coupled to the animated figure, and a third controller communicatively coupled to the light emitter, wherein the first controller, the second controller, and the third controller are configured to communicate with one another to coordinate operation of the actuator, the animated figure, and the light emitter.

13. The show effect system of claim 8, comprising a display coupled to a first side of a wall of the enclosure, wherein the actuator is coupled to a second side, opposite the first side, of the wall.

14. The show effect system of claim 8, comprising a fluid output device coupled to the enclosure and configured to output a fluid into the interior space of the enclosure.

15. An attraction system for an amusement park, the attraction system comprising:
an actuator;
a support coupled to the actuator, wherein the support defines a space;
a display in engagement with the support within the space of the support, wherein the display is configured to output imagery;
an animated figure in engagement with the support within the space of the support, wherein the animated figure is configured to move within the space; and
a control system communicatively coupled to the actuator, the display, and the animated figure, wherein the control system is configured to perform operations comprising:
operating the actuator to move the support and drive corresponding movement of the display and the animated figure;
operating the display to adjust the imagery output by the display; and
operating the animated figure to move the animated figure within the space.

16. The attraction system of claim 15, wherein the control system comprises a primary controller, a first secondary controller communicatively coupled to the actuator, a second secondary controller communicatively coupled to the display, and a third secondary controller communicatively coupled to the animated figure, the primary controller is communicatively coupled to the first secondary controller, the second secondary controller, and the third secondary controller, and the primary controller is configured to communicate with the first secondary controller, the second secondary controller, and the third secondary controller to coordinate operation of the actuator, the display, and the animated figure.

17. The attraction system of claim 16, comprising a sensor, wherein the primary controller is communicatively coupled to the sensor, and the primary controller is configured to communicate with the first secondary controller, the second secondary controller, and the third secondary controller based on data received from the sensor.

18. The attraction system of claim 17, wherein the sensor comprises a motion sensor, a location sensor, a shape detector, a gaze detector, or any combination thereof configured to detect a parameter of a ride vehicle or a guest.

19. The attraction system of claim 15, comprising a ride vehicle external to the space of the support, wherein the control system is configured to operate the actuator to move the support and drive corresponding movement of the display and the animated figure relative to the ride vehicle.

20. The attraction system of claim 15, comprising a backing coupled to the support, wherein the display is coupled to the backing, and the backing is configured to block deformation of the display caused by movement of the support via the actuator.
